(19) United States
(12) Patent Application Publication
(10) Pub. No.: US 2018/0093615 A1
(43) Pub. Date: Apr. 5, 2018

(54) SUPPORT LEDGE

(71) Applicant: F. BARKOW, INC., Milwaukee, WI (US)

(72) Inventor: JOHN R. WEISE, Cedarburg, WI (US)

(73) Assignee: F. BARKOW, INC., Milwaukee, WI (US)

(21) Appl. No.: 15/720,652

(22) Filed: Sep. 29, 2017

Related U.S. Application Data
(60) Provisional application No. 62/402,085, filed on Sep. 30, 2016.

(51) Int. Cl. B60R 9/02; B25H 5/00

(52) U.S. Cl. CPC B60R 9/02; B25H 5/00

(57) ABSTRACT

A material supporting ledge configured to be attached to a horizontal slat of a material carrying rack. The support ledge includes a vertical member having a hook portion and a supporting flange. A support member extends laterally from the vertical member.

### RELATED APPLICATION

This application claims the benefit of U.S. Provisional Patent Application Ser. No. 62/402,085, filed 30 Sep. 2016, and entitled “Support Ledge.”

### BACKGROUND OF THE INVENTION

This present invention is directed to article carriers for transporting articles such as stone or plate glass. A pickup truck, or other small truck or van, is normally used to deliver articles on short trips. Large trucks, freight cars and other enclosed carriers are normally used to haul articles on long trips. Racks may be used in the glass industry to assist in the transport of large pieces of glass. Such racks are typically mounted on small trucks, pickup trucks or are completely enclosed inside of a delivery vehicle and are configured to secure large pieces. Smaller pieces may be more problematic as known racks are not typically designed to carry smaller or irregularly shaped pieces.

Particularly, this invention is configured to optimally carry bulky articles such as plate glass and stone, particularly those having a smaller or irregular size.

### SUMMARY OF THE INVENTION

A support ledge to securely and safely transport bulky articles such as plate glass on a rack is disclosed. The present invention provides an easy to use support ledge for use in the glass transportation industry. The support ledge further includes a support surface, and may optionally include a liner or pad having a high coefficient of friction for additional security. The present support ledge is arranged to interface with racks having slats and for use in most commercial vans and some passenger vehicles.

In a preferred embodiment, the support ledge provides an easy to use support system which prevents unwanted movement of the bulky article, such as plate glass, during transport. The support ledge may be used in conjunction with racks on driver side or passenger side, vans, pickup trucks, or other suitable vehicle.

### BRIEF DESCRIPTION OF THE DRAWINGS

FIG. 1 is a perspective view of a vehicle having a rack arranged to accept a support ledge according to the present invention.

FIG. 2 is a perspective view of a support ledge according to the present invention.

FIG. 3 is a side view of the support ledge illustrated in FIG. 2.

FIG. 4 is a front view of the support ledge illustrated in FIGS. 2 and 3.

FIG. 5 is a side view, similar to that of FIG. 3, but showing the support ledge in proximity to a rack slat.

FIG. 6 is a view similar to that of FIG. 5, but showing the support ledge attached to the rack slat.

FIG. 7 is a perspective view of the support ledge illustrated in FIGS. 2-6 and attached to a rack slat.

FIG. 8 is a perspective view similar to that of FIG. 1, but showing the support ledge in place on a rack slat and material secured thereon for transport.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

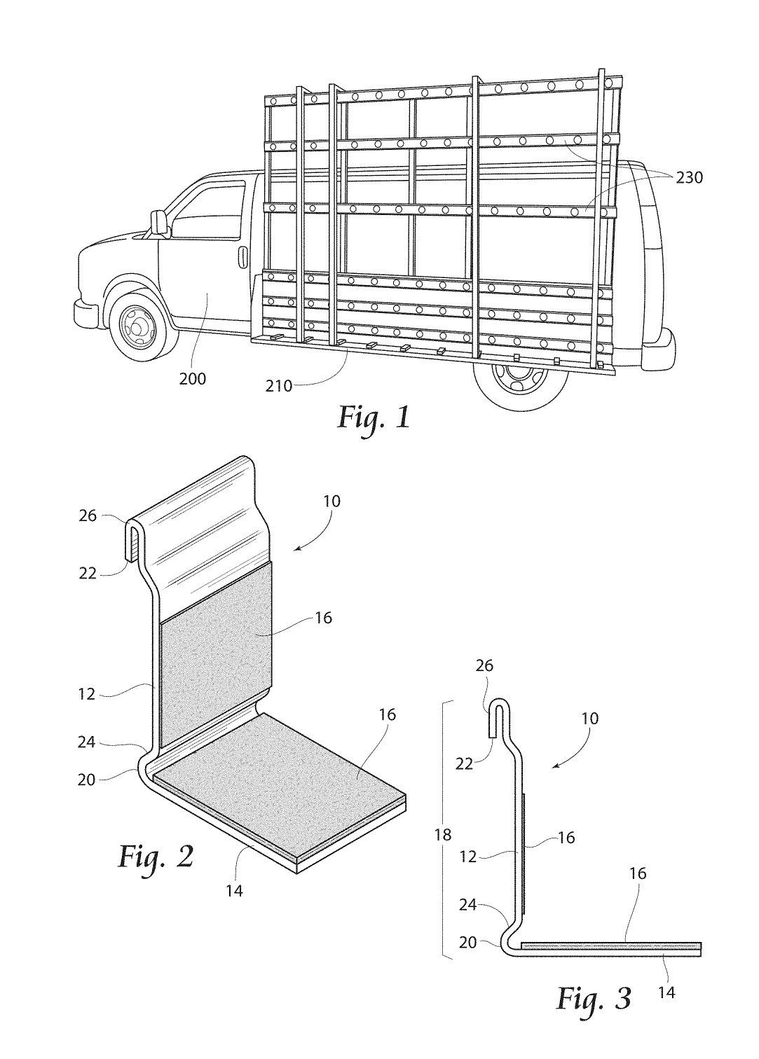

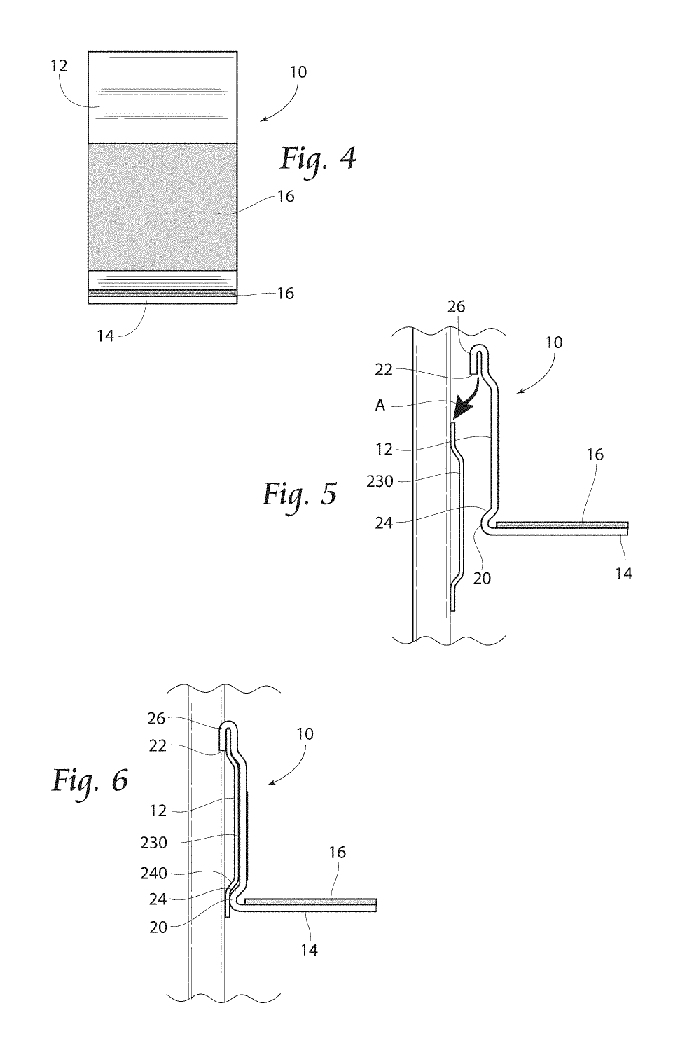

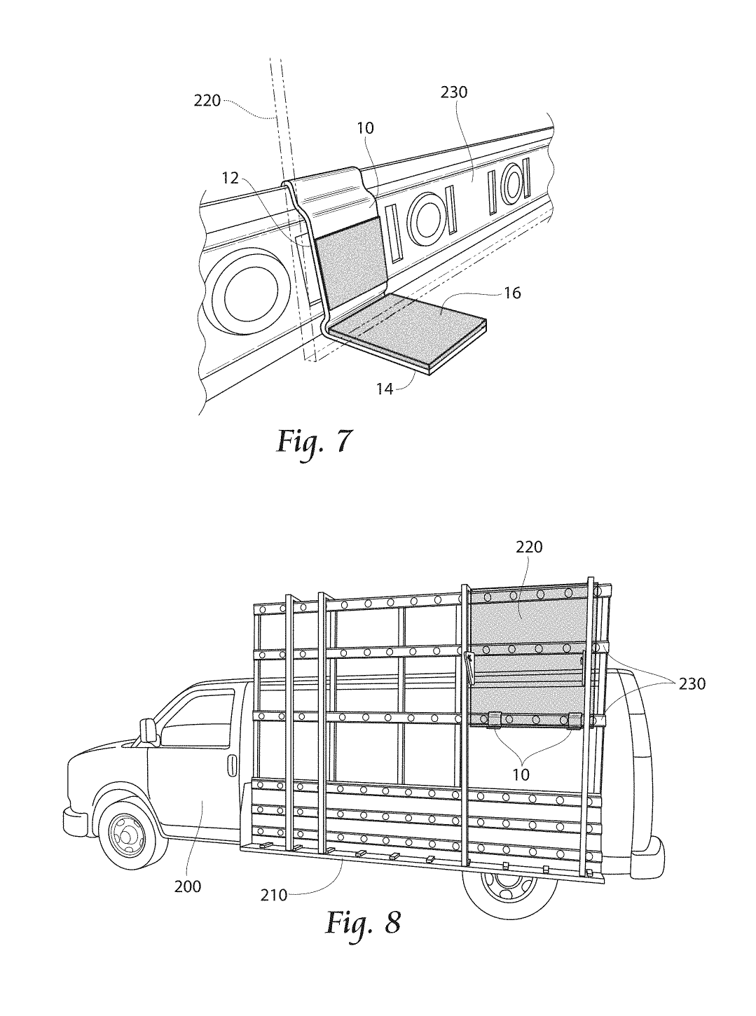

FIG. 1 illustrates a vehicle 200 having a rack 210 of the type for use with the present invention. As shown, the rack 210 is arranged to securely and safely transport bulky articles such as plate glass 220 (see FIGS. 7 and 8). FIGS. 2-4 illustrate a material supporting ledge 10 according to the present invention and arranged to interface with a horizontal slat 230 of a material carrying rack 210, such as the rack 210 illustrated in FIG. 1. The present invention provides a support ledge 10 arranged to interface with a rack 210 having slats 230, such as the rack 210 shown in FIG. 1, and for use in the glass transportation industry, although it is be understood that other uses may be envisioned. The support ledge 10 is arranged to support glass 220 or other bulk objects having a smaller size than that transported by a typical rack 210. The support ledge 10 may preferably include a vertical member 12 and a support member 14. The support ledge 10 of the present invention may further preferably include at least one friction pad 16 attached to at least one of the vertical member 12 and the support member 14.

With attention to FIGS. 2 and 3 it may be seen that the support ledge 10 includes a vertical member 12 and a laterally extending support member 14. As shown, the vertical member 12 includes a vertical profile 18 having a proximal end 20 and a distal end 22 with the proximal end 20 including a supporting flange 24 arranged to interface with a slat 230, as will be discussed. Moreover, the support member 14 extends laterally from the proximal end 20 of the vertical member 12. As further shown, the distal end 22 terminates in a hook portion 26 arranged to engage and secure to a generally horizontal slat 230 of a rack 210. The laterally extending support member 14 may further optionally include a pad 16 having a high coefficient of friction. The pad 16 may be fabricated from neoprene or other suitable material to protect the glass 220 or like object during transport. Moreover, the vertical member 12 may also be provided with a pad 16 if desired, although it is within the scope of the invention to provide either or both the vertical member 12 and support member 14 with a pad 16 as may be desired. In a preferred embodiment, a plurality of support ledges 10 may be arrange to support and carry individual or plural materials 220 (See FIG. 8). As seen, the support ledge 10 may be adjustable along slat 230 locations as may be desired by the user and particular material to be transported.

As seen in the views of FIGS. 2-6, the profile 18 of the support ledge 10 allows for facile mounting on a selected slat 230 as may be desired by the user. The versatility of the support ledge 10 further allows a support ledge 10 to be utilized in different arrangements as may be required by article size and shape. The support ledge 10 is adapted to fit racks 210 having slats 230 and fitting most commercial vans and some passenger vehicles 200, and which helps prevent unwanted movement of the bulky article, such as plate glass 220, during transport.

In use, and as viewed particularly in FIGS. 5-8, the hook member 26 is latched over a selected slat 230 of a rack 210 mounted on a vehicle 200. As shown in FIG. 5, the hook member 26 is inserted over the selected slat 230 in the direction of arrow A, until the hook member 26 fully engaged. FIG. 6 illustrates the support ledge 10 in place with the supporting flange 24 buttressed against a lower part 240 of the slat 230. FIG. 7 shows the support ledge 10 installed on a selected slat 230 with an article, such as the glass 220 shown, resting thereon.

A support ledge 10 according to the present invention is easily mounted on and removable from slats 230 of a transport rack 210 without the need for tools. The support ledge 10 may be easily moved to different locations on the rack slats 230 for versatility of loading and transporting irregular or smaller materials, such as glass 220, on a vehicle 200. For example, FIG. 8 illustrates a vehicle 200 having a rack 210 and two ledges 10 installed to transport a small piece of glass 220.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A support ledge including:
a vertical member having a proximal end and a distal end, the proximal end including a flange portion; and
a support member extending laterally from the proximal end of the vertical member.

2. The support ledge of claim 1 wherein the distal end terminates in a hook portion.

3. The support ledge of claim 2 wherein the laterally extending support member further includes a pad member having a high coefficient of friction.

4. The support ledge of claim 3 wherein the pad member is fabricated from neoprene.

5. The support ledge of claim 4 wherein the vertical member is provided with a pad member.

6. The support ledge of claim 2 further including at least one pad member.

7. The support ledge of claim 6 wherein the at least one pad member is attached to at least one of the vertical member and the support member.
